(19) United States
(12) Patent Application Publication
(10) Pub. No.: US 2023/0083593 A1
(43) Pub. Date: Mar. 16, 2023

(54) CLEANING DEVICE AND CLEANING SYSTEM

(71) Applicant: Vorwerk & Co. Interholding GmbH, Wuppertal (DE)

(72) Inventors: Monika Lindner, Solingen (DE); David Erkek, Aarau (CH); Dirk Höhne, Hückeswagen (DE); Andreas Schmidt, Mettmann (DE)

(21) Appl. No.: 17/940,074

(22) Filed: Sep. 8, 2022

(30) Foreign Application Priority Data
Sep. 15, 2021 (EP) 21196937.3

(51) Int. Cl. B25J 9/16; B25J 11/00

(52) U.S. Cl. CPC B25J 9/1664; B25J 11/0085; H04L 67/12

(57) ABSTRACT

A cleaning device having an electrical interface for interacting with an electrical counter-interface and a base station to charge the cleaning device. The cleaning device being configured to move autonomously in a processing environment, to carry out cleaning tasks, and to move into a service position with a base station. The cleaning device determines a range of service functions offered by a base station. When the cleaning device is in the service position, at least one measured value of a voltage or measured value of a voltage curve at the electrical interface provides a means of identification. This identification is used to determine the range of service functions at the base station or to identify a communication interface for use in determining the range of service functions by a data processing device. A cleaning system, a procedure, and a computer program product associated with the cleaning device is provided.

### CROSS REFERENCE TO RELATED APPLICATIONS

This application claims the benefit of priority under 35 U.S.C. § 119 to European Patent Application No.: 21196937.3, filed Sep. 15, 2021, the contents of which is incorporated herein by reference in its entirety.

### FIELD

The invention involves a cleaning device, specifically a cleaning device that is designed for autonomous movement in a processing environment.

### BACKGROUND

The statements in this section merely provide background information related to the present disclosure and several definitions for terms used in the present disclosure and may not constitute prior art.

Generic cleaning devices are known in a large number of configurations. There are cleaning devices designed, for example, as robot vacuums, robot mops, or robot vacuums and mops. These types of cleaning devices usually have at least one data processing device, which, with a number of sensors, ensures navigation of the cleaning device in the processing environment and controls the completion of cleaning tasks in the processing environment. In particular, in order to enable systematic movement of the cleaning device in the processing environment, a map of the processing environment is created by means of the data processing device, which is continuously adjusted, for example, or a map of the surrounding area that is provided is continuously adjusted. The “map of the environment” is kept ready in a format that can be processed and interpreted by the data processing device. The presence of a map of the environment supports, for example, finding a base station for service purposes.

Depending on the design of the cleaning device, the service purposes, i.e., the tasks to be performed on a cleaning device in the service position, can include charging an energy storage device, in particular a battery, emptying a dirt collection container and/or regenerating wet cleaning pads.

Particularly in the case of cleaning systems with multiple base stations and/or multiple cleaning devices, the challenge exists that the service required for a specific cleaning device at a specific point in time cannot be processed by every base station in the cleaning system. For example, only a single base station can empty a dirt collection container, while all base stations can charge energy storage devices.

In order to be able to guide itself to the base station that is suitable for the currently required service requirement, the cleaning device requires information about the range of service functions of the base station used in the cleaning system or of all the base stations used in the cleaning system.

An objective of the present disclosure is to specify a cleaning device, a cleaning system and a computer program product that enable a determination of a service function range for a base station.

### SUMMARY

The present disclosure involves a cleaning device, specifically a cleaning device that is designed for autonomous movement in a processing environment. The cleaning device has at least one electrical interface for interacting with an electrical counter-interface of at least one base station. When interacting, for example, electrical contact is made and an energy storage system of the cleaning device is charged by means of voltage provided at the electrical interface.

The cleaning device is designed and set up to, at a minimum, move into a service position at a base station for service purposes. At least in the service position, voltage can be applied to the electrical interface, in particular for charging the energy storage device of the cleaning device.

The aforementioned objective is achieved with a generic cleaning device having at least one electrical interface for interacting with an electrical counter-interface of at least one base station at least for charging an energy storage device of the cleaning device, wherein the cleaning device is at least designed and set up to move autonomously in at least one processing environment, to carry out cleaning tasks and to move into a service position at a base station for service purposes. The cleaning device is characterized by it also designed and set up, at a minimum, to determine at least one measured value of a voltage present at the electrical interface as a means of identification, at least in the service position. As an alternative or in addition to this, the cleaning device is designed and set up, at a minimum, in such a way that at least one measured value of a voltage curve present at the electrical interface is determined as a means of identification. The cleaning device uses the means of identification to determine at least one range of service functions of the base station or at least to provide the means of identification at at least one communication interface for use in the determination of a range of service functions by a data processing device.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

In order that the disclosure may be well understood, there will now be described various forms thereof, given by way of example, reference being made to the accompanying drawings, in which:

FIG. 1 shows a side view of a cleaning device according to the teachings of the present disclosure;

FIG. 2 shows a side view of another cleaning device according to the teachings of the present disclosure;

FIG. 3 shows a partially sectioned side view of a cleaning device according to the teachings of the present disclosure;

FIG. 4 shows a schematic representation of another embodiment of a cleaning device according to the teachings of the present disclosure;

FIG. 5 shows a schematic representation of a processing environment according to the teachings of the present disclosure;

FIG. 6 shows a schematic representation of the process according to the teachings of the present disclosure; and

FIG. 7 shows a voltage curve plotted as a function of time at an electrical interface of a cleaning device in a service position at a base station.

The drawings are provided herewith for purely illustrative purposes and are not intended to limit the scope of the present invention.

### DETAILED DESCRIPTION

The following description is merely exemplary in nature and is in no way intended to limit the present disclosure or its application or uses. It should be understood that throughout the description, corresponding reference numerals indicate like or corresponding parts and features.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

In general, the cleaning device has at least one electrical interface for interacting with an electrical counter-interface of at least one base station at least for charging an energy storage device of the cleaning device. The cleaning device is at least designed and set up to move autonomously in at least one processing environment, to carry out cleaning tasks and to move into a service position at a base station for service purposes. The cleaning device is characterized by it also designed and set up, at a minimum, to determine at least one measured value of a voltage present at the electrical interface as a means of identification, at least in the service position. As an alternative or in addition to this, the cleaning device is designed and set up, at a minimum, in such a way that at least one measured value of a voltage curve present at the electrical interface is determined as a means of identification. The cleaning device uses the means of identification to determine at least one range of service functions of the base station or at least to provide the means of identification at at least one communication interface for use in the determination of a range of service functions by a data processing device.

The electrical interface is in particular the charging interface of the cleaning device for charging at least one energy storage device of the cleaning device. The energy storage device is, for example, a battery or a supercapacitor.

Using at least one means of identification, i.e., the measured value of at least one voltage present at the electrical interface and/or a voltage curve present at the electrical interface, the cleaning device—specifically a data processing device in the cleaning device—determines at least one range of service functions of the base station. The range of service functions includes information about the tasks that can be performed by the base station, for example, charging the energy storage device, emptying the dirt collection container, etc.

Each data processing device, in particular the data processing device of the cleaning device, consists of, for example, at least one processor device for carrying out calculation operations, at least one specifically non-volatile storage device for storing data, and preferably at least one communication device.

Alternatively, or in addition, it is provided that the at least one means of identification, i.e. the at least one measured value of the voltage and/or the at least one measured value of the voltage curve is provided at least one communication interface of the cleaning device for use in determining a range of service functions by a specifically spatially separated data processing device. The data processing device that is specifically spatially separated is, for example, a server that is accessible via the Internet, specifically via a cloud computer, a user's mobile data processing device, for example a smartphone, a tablet or a laptop, a data processing device of another cleaning device and/or a data processing device of a base station.

It is provided that the comparison of the measured values with the stored measured values takes into account a tolerance within which a measured value is assigned to a voltage measured value if the measured value deviates from the stored voltage measured value, for example, a tolerance of ±2%, ±5% or ±10% of the stored voltage measured value.

The voltage present at the electrical interface is, for example, a standardized charging voltage with a deviation that exceeds the usual tolerance ranges. The deviation is preferably chosen to be so significant for each type of base station that it clearly differs from the usual voltage tolerances and therefore no misidentification can take place. The deviation is preferably temporary for the purpose of being measured by the cleaning device and is adjusted again to a standardized value for the actual charging process of the energy storage device. It is therefore specifically provided that the voltage present at the electrical interface is changed only at a predetermined point in time, after a predetermined time elapse, or for a predetermined period of time, and then a planned charging voltage is present again.

For example, the voltage present at the electrical interface for the purpose of identification for each type of base station is a few volts above or below the charging voltage provided for charging the energy storage device. It is also provided that the base stations permanently provide slightly different charging voltages, each individually characteristic of a type of base station. The voltage is then a few volts above or below a standardized charging voltage.

In particular, it is provided that multiple measured values are determined. The measurement of a continuous voltage curve over a predetermined period of time is regarded as a measured value, for example.

The determination of the measured value of the applied or provided voltage and/or the measured value of the voltage curve is preferably carried out by means of a charging control device assigned to the energy storage device, specifically a battery. The charging control device is usually designed and set up to monitor and control the charging of the energy storage device.

When arranging the cleaning device in the service position on a base station, at least the electrical interface of the cleaning device interacts with an electrical counter-interface of the base station in such a way that an electrical voltage present at the electrical counter-interface can be transmitted.

The cleaning device has, for example, at least one blower motor, e.g. for suction work, at least one drive, for example, with at least three rollers or wheels, at least one motor for at least one cleaning tool, at least one cleaning tool, specifically at least one rotatable brush or a wet cleaning tool, and/or at least one sensor, preferably multiple sensors.

In order to implement the provision of various voltage values at the electrical counter-interface, the base station preferably has multiple electrical resistors with mutually different resistance values, as well as multiple switching elements that can be controlled by a data processing device of the base station in such a way that a predetermined output voltage is present at the electrical counter-interface.

For example, it is provided that the electrical interface has at least two electrical contacts that are physically contacted with mating contacts on a base station. For example, the electrical contacts or counter-contacts are designed as spring-loaded contact surfaces or as contact pins and contact sockets.

As an alternative to this, provision is made, for example, for the electrical interface to have at least one secondary coil, which is designed to interact with a primary coil in a base station. The energy storage device is then charged inductively so that there is no physical contact between the electrical interface and the electrical counter-interface, but there is still “contact” and interaction takes place.

The cleaning device of the present disclosure has the advantage over the state of the art that no additional hardware is required to determine the range of the service functions, since cleaning devices already have electrical interfaces specifically for charging the energy storage device, as well as charging management systems and charging control. Through the advantageous determination of the range of service functions, the cleaning device can uniquely identify a base station and control it efficiently as a function of the current service requirement as part of the cleaning strategy.

A first embodiment of the cleaning device according to one aspect of the present disclosure provides that the determination of the range of service functions involves the comparison, at a minimum, of at least one determined measured value with a voltage measured value stored in at least one storage device. In this case, different voltage measured values are assigned to base stations with different ranges of service functions in the storage device. By comparing the measured value determined for the voltage with the measured values stored in the storage device, the base station is immediately identified and the range of the service functions is therefore determined. For example, the storage device is designed as a non-volatile storage device or as a database, specifically in a non-volatile storage device, in which the voltage measured values and the associated ranges of service functions are kept available.

For example, it is provided that the storage device, specifically the database, is kept available by a data processing device of the cleaning device. The measured value determined in each case is made available to the data processing device and an association or comparison with the stored voltage measured values is carried out.

As an alternative to this, it is provided that the storage device, specifically the database, is kept available on a spatially separated data processing device. For example, to determine the range of service functions, the data processing device of the cleaning device accesses the storage device, specifically the database, on the spatially separated data processing device via at least one communication interface in order to compare the determined measured value with the stored voltage measured values. The spatially separated data processing device is, for example, a server accessible via the Internet, specifically a cloud computer, a user's mobile data processing device, for example a smartphone, a tablet or a laptop, a data processing device of another cleaning device and/or a data processing device of a base station.

The determination of at least one measured value of the voltage or the voltage curve can take place at different times. According to a further embodiment of the cleaning device, it has proven to be advantageous if the cleaning device is designed and set up in such a way that at least one measured value of the voltage and/or at least one measured value of the voltage curve is recorded immediately after the cleaning device has been arranged in the service position, specifically immediately after contacting of the electrical interface with the electrical counter-interface. The determination of the measured value or a plurality of measured values consequently takes place immediately, i.e. without any time delay, after the cleaning device is properly arranged in the service position and the electrical interface is contacted with the electrical mating interface. Subsequently, the determination of the range of the service functions takes place, so that the range of the service functions is determined immediately after the cleaning device is arranged in the service position of a base station. Preferably, it is provided that the determination of the range of the service functions is carried out each time a cleaning device is arranged in the service position of a base station.

It is also provided that, alternatively or additionally, at least one measured value of the voltage is determined at least one predetermined point in time. For example, a point in time is defined at which the measured value is determined, for example after an initialization process has been carried out between the cleaning device and the base station after being arranged in the service position or at any other predeterminable point in time.

It is particularly preferred that alternatively or additionally, at least one measured value of the voltage and/or a measured value of the voltage curve is determined after at least a predetermined time elapse after the cleaning device has been connected with the base station, in particular after the cleaning device has been arranged in the service position. For example, the relevant point in time at which the measured value is determined is after a predetermined time has elapsed after the electrical interface has made contact with the electrical counter-interface, for example 1, 2, 3, 4, 5, 10 or 15 seconds. The cleaning device and the base station are advantageously designed in such a way that at this point in time the relevant voltage is provided by the base station at the electrical counter-interface, or at this point in time a detection is also carried out by the cleaning device.

It is further provided that at least one measured value or multiple measured values to be recorded over a predetermined period of time. For example, the determination of measured values or at least one measured value takes place within 10 or 15 seconds after the cleaning device is arranged in the base station or for a predetermined period of time from any predetermined point in time, specifically after the cleaning device is arranged in the service position.

If a measured value of a voltage curve is determined, multiple measured values are preferably determined. The voltage curve over time is preferably chosen to be characteristic in such a way that it differs significantly from other voltage curves over time, and this characteristic voltage curve can therefore be used to clearly identify the range of the service functions of the base station. The measured value is then the voltage curve.

Advantageously, in order to be able to take into account the determined range of service functions of a base station for an efficient work strategy for the cleaning device, according to a further embodiment of the cleaning device, it is provided that the cleaning device is also designed and set up in such a way that the determined range of service functions of each base station is combined with position data of the respective base station in the processing environment, specifically in an environment map created by the cleaning device, preferably the data processing device of the cleaning device. Consequently, the cleaning device assigns the determined range of service functions to a position in the processing environment. In this way, the cleaning device can specifically guide itself to this base station if it needs the range of service functions provided by the base station.

Since the position of a base station can be changed by a user, it is preferably provided that the range of service functions is determined each time the cleaning device is arranged in a service position of the base station, and that the stored data, specifically regarding the range of service functions and the position of the base station, are updated if necessary.

It is advantageously provided that the cleaning device takes into account the range of service functions linked to the respective position data of the base station when creating and/or adjusting a navigation and/or cleaning task plan for the cleaning device. The cleaning device preferably moves in a coordinated manner in the processing environment, in particular when carrying out cleaning tasks, for example, systematic paths are followed and/or at least certain areas of the processing environment are cleaned. Through the knowledge and position of the range of service functions of a base station, the cleaning device can coordinate the navigation and the cleaning tasks with one another in such a way that a base station with the required range of service functions is available in the local vicinity at a point in time or during a period of time when the range of service functions is required by the cleaning device.

In particular, a navigation and cleaning strategy of the cleaning device can be further improved according to a further embodiment of the cleaning device in that the cleaning device is designed and set up in such a way that it uses at least one determined range of service functions in combination with position data and at least one other item of data from: data on the size of the processing environment, data on the degree of soiling of at least part of processing environment, data on the status of an energy storage device of the cleaning device, in particular the charge status of a battery, data on the regeneration of a wet cleaning pad and/or data on the fill level of a dirt collection container, to determine at least one probable point in time or period of time for a service requirement of the cleaning device.

If the probable point in time or period of time for the service requirement is determined, for example for charging an energy storage device, cleaning a dirt collection container, etc., it is preferably provided that this is used when creating and/or adjusting a navigation and/or cleaning task plan. It is preferably provided that the information about the probable point in time or period of time is used in such a way that the cleaning device is at least in the local vicinity of a base station at the probable service time or service period, which, with its range of service functions, can process a service range for the cleaning device that is required at the probable service time. In particular, it is provided that the probable point in time or period of time of the service requirement is used to coordinate the service requirement with other cleaning devices, specifically that the occupancy of at least one base station or multiple base stations is coordinated with other cleaning devices.

In this way, the cleaning device can carry out its navigation and cleaning tasks efficiently, and the times for carrying out services at base stations are reduced to a minimum. This also prevents the cleaning device from having to travel unnecessarily long distances to complete service tasks.

According to a further embodiment of the cleaning device, it is provided that the cleaning device is also designed and set up in such a way, specifically using the data processing device of the cleaning device, to determine a current service requirement of the cleaning device at a specific point in time. At least one suitable base station is then selected using information stored in a storage device about service ranges of various base stations, and then the cleaning device is specifically moved to the selected base station with the known position data. If no range of service functions is known for any base station, movement to any base station preferably takes place to determine its range of service functions.

The cleaning device is preferably designed and set up in such a way that it can make a selection from multiple base stations at any time. If, for example, the energy storage device needs to be charged, but the dirt collection container does not yet have to be emptied, a base station that is only suitable for charging the energy storage device can be selected. If, for example, the collection container also has to be emptied of dirt, but the base station that provides this range of service functions is currently occupied, the cleaning device is designed and set up to initially control a first base station in order to process a first part of the service requirement, for example charging the energy storage device, and then to guide itself to at least one other base station in order to process at least a second part of a service requirement, for example to empty a dirt collection container. The cleaning device is consequently designed and set up to select at least one base station with a known range of service functions.

Preferably, in order to further increase the efficiency of the completion of cleaning tasks, according to a further embodiment of the cleaning device, it is provided that it is also designed and set up in such a way, using at least one determined range of service functions for at least one base station and using at least one further cleaning characteristic of: data on the usual soiling of the processing environment, data on a desired cleaning intensity of the processing environment, data on the capacity of a dirt collection container of the cleaning device, data on the regeneration of a wet cleaning pad and/or the maximum running time of an energy storage device and/or data determined from previous navigation and/or cleaning movements on the usual soiling of the processing environment, data on a desired cleaning intensity of the processing environment, data on the capacity of a dirt collection container of the cleaning device, data on the regeneration of a wet cleaning pad and/or the maximum running time of an energy storage device to determine at least one optimized location for the respective base station in the base station.

Using at least part of the aforementioned data, the cleaning device can determine an optimized location for each base station depending on its range of service functions. Therefore, based stations that are only designed for charging can be arranged at a different location than those that are suitable for regenerating a wet cleaning pad or for emptying a dirt collection container.

It is advantageously provided that at least one determined, optimized location is provided via at least one display device, preferably one that is separated spatially. For example, the display device can be a user's mobile data processing device, such as a smartphone or tablet. “Spatially separated” means, for example, that it is arranged not in or on the housing of the cleaning device.

An optimized location is characterized by the fact that it optimally fulfills the requirements of an efficient navigation and cleaning strategy.

Preferably, it is provided that the cleaning device is designed and set up in such a way to determine multiple optimized locations in the processing environment for a base station, specifically to show the determined, optimized locations to a user via at least one, preferably spatially separated display device. On the basis of the parameters mentioned above, the cleaning device preferably determines multiple locations that can be regarded as optimized locations, possibly with different degrees of suitability.

Furthermore, it is also provided that the determination of at least one optimized location, preferably multiple optimized locations, is carried out on a spatially separated data processing device and then shown to the user on a display device. A server, specifically a cloud server, or also a mobile data processing device of the user, for example a smartphone or a tablet, which can also serve as a display device, and/or the data processing device of another cleaning device or another base station is suitable here as a spatially separated data processing device.

According to a further embodiment, it has proven to be particularly advantageous if it is provided that at least one optimized location, preferably multiple optimized locations, can be rejected by a user via an input device, for example a tablet or a smartphone, or can be confirmed as a future location. If an optimized location is confirmed by the user as an optimized location, it is saved as such by the cleaning device. The user then has to move the base station for which the optimized location has been determined to the location determined as the optimized location. A different orientation of a base station is also considered to be an optimized location.

In order to be able to respond to the user's wishes with regard to the arrangement of a base station, it is provided according to a further embodiment that the cleaning device is also designed and set up in such a way that it has at least one input device, for example an input device designed on the cleaning device or by means of a spatially separated input device through a communication interface, which can receive data about at least one preferred location in the processing environment. The preferred location is transmitted to the cleaning device by the user. The cleaning device is also designed and set up in such a way that, using the data of at least one preferred location, the determined range of service functions for at least one base station using data of at least one additional cleaning characteristic of data on the usual soiling of the processing environment, data on the desired cleaning intensity of the processing environment, data on the collection capacity of a dirt collection container, data on the regeneration of the wet cleaning pad and/or the maximum running time of an energy storage device and/or data on the usual soiling of the processing environment determined for previous navigation and/or work movements, data on the desired cleaning intensity of the processing environment, data on the collection capacity of the dirt collection container, data on the regeneration of a wet cleaning pad and/or the maximum running time of an energy storage device of the preferred location is evaluated in regard to its suitability as a location in the context of a navigation and/or cleaning task plan. Depending on this evaluation, the user is preferably given a result in regard to whether a base station should be positioned at the preferred location or whether the preferred location is not suitable as a location for a base station.

Furthermore, it is provided that the user can enter multiple preferred locations via an input device and each of the preferred locations is evaluated by the cleaning device with regard to its suitability, in particular with various degrees of suitability.

The objective of the present disclosure mentioned at the outset is also achieved by a cleaning system that has at least one base station and at least one cleaning device, specifically according to one of the previously described embodiments. The cleaning device has at least one electrical interface, specifically a charging interface, for interacting with an electrical counter-interface, specifically an electrical charging counter-interface, of the base station, at a minimum for charging the cleaning device's energy storage device. The cleaning device is designed and set up to move autonomously at a minimum in a processing environment, to carry out cleaning tasks in the processing environment and to move into a service position at least one base station for service purposes. In the service position, voltage for the energy storage device of the cleaning device can be or is provided via the electrical counter-interface and the electrical interface.

The cleaning device is also designed and set up to determine at least one measured value of a voltage present at the electrical interface and/or at least the measured value of a voltage curve present at the electrical interface as a means of identification, at least in the service position. Using the means of identification, i.e. at least one measured value, at least one range of service functions of the base station is determined, or the means of identification, i.e. at least one measured value is provided at at least one communication interface for the determination of the range of service functions by means of one specifically spatially separated data processing device.

According to another embodiment of the cleaning system, there are at least two cleaning devices and/or at least two base stations. Specifically, each cleaning device is designed and set up to determine the range of service functions of each base station in its respective service position, or to provide the at least one measured value at least one communication interface for use in determining the range of service functions by a data processing device, specifically a data processing device that is spatially separated.

A further embodiment of the cleaning system provides that at least two, specifically multiple base stations, are present, and that a difference in the voltages can be determined at the electrical interface for the base stations with different functional ranges with at least 0.5 V, specifically at least 1 V, preferably at least 2 V.

The difference in the voltages provided by the base stations in order to distinguish the base stations from one another consequently differs by at least 0.5 V, specifically by at least 1 V, preferably by at least 2 V. The greater the voltage difference, the less susceptible the system is to incorrect assignments due to voltage fluctuations. The base station is preferably designed and set up to provide different voltages at the electrical counter-interface.

Specifically, the base station is designed and set up to control the electrical counter-interface in such a way that the voltage that can be measured by the cleaning device is changed at least temporarily, specifically at least at a predetermined point in time, and/or that a predetermined voltage curve is generated specifically over a predetermined period of time.

A further embodiment of the cleaning system provides that at least one data processing device is present. For example, the cleaning system has a spatially separate data processing device, e.g. a server, or the data processing device of the cleaning device is used. The data processing device is designed and set up specifically to determine a service requirement for at least one cleaning device at least one point in time and, using the current service requirement, to select at least one base station that is at least partially suitable for this service requirement. Furthermore, the data processing device is designed and set up to direct the cleaning device to go to the service position of at least the selected base station or to direct the cleaning device to go to the service station at any base station to determine the range of service functions. Preferably, the data processing device transmits data to the cleaning device, specifically to the data processing device of the cleaning device, and this data contains information through which the selected base station can be identified.

The initially mentioned objective is also achieved by a process for operating at least one cleaning device that has at least one electrical interface for interacting with an electrical counter-interface of at least one base station for charging at least one energy storage device of the cleaning device. The cleaning device is designed and set up to move autonomously, at a minimum, in a processing environment, to carry out cleaning tasks and to move into a service position at a base station for service purposes. In the service position, voltage is provided via the electrical interface. The method comprises the following process steps, at a minimum:
Determining at least one measured value of the voltage at the electrical interface of the cleaning device in the service position and/or determining at least one measured value of a voltage curve at the electrical interface of the cleaning device in the service position as a means of identification,
Determining at least one range of service functions of the base station using the means of identification by comparing, at a minimum, the determined measured value of the voltage and/or the measured value of the voltage curve with the measured values of the voltage that are available in at least one storage device, specifically a database, wherein the measured values of the voltage that are available in the storage device, specifically the database, are associated with data on the range of service functions of different base stations.

The present disclosure also involves a computer program product comprising instructions which, when the program is executed by the processor unit of a data processing device, direct it to determine at least one required current service requirement for a cleaning device at least one point in time, and using data on known service function ranges assigned to individual base stations, to select at least one suitable base station for processing at least part of the current service requirement, and to direct the cleaning device to move to the service position at the selected base station.

The computer program product can be executed either by the data processing device of the cleaning device or by a spatially separated data processing device that is connected to the data processing device of the cleaning device via at least one communication interface. The spatially separated data processing device is, for example, a server or a user's mobile data processing device, for example a smartphone or a tablet. The computer program product consequently controls the determination of the required service requirement and then the selection of a base station that is suitable for processing the service requirement. According to a first embodiment, the computer program product is preferably designed in such a way that multiple base stations can also be approached by the cleaning device in order to carry out the range of service functions, for example in order to process part of the service requirement in each case. The computer program product preferably controls the cleaning device in such a way that the cleaning device first controls a first base station for processing at least a first part of the service requirement and then at least a second base station for processing at least a second part of the service requirement.

Further advantageous embodiments according to the present disclosure result from the following description of the figures.

In the various figures, the same parts are always indicated with the same reference numbers.

In the following description, it is emphasized that the present disclosure is not limited to the exemplary embodiments, and that it is not limited to all or multiple features of the combinations of the features described. Instead, each individual partial feature of each exemplary embodiment is also detached from all other partial features described in connection with it and also in combination with any of the features of another exemplary embodiment of significance for the object of the present disclosure.

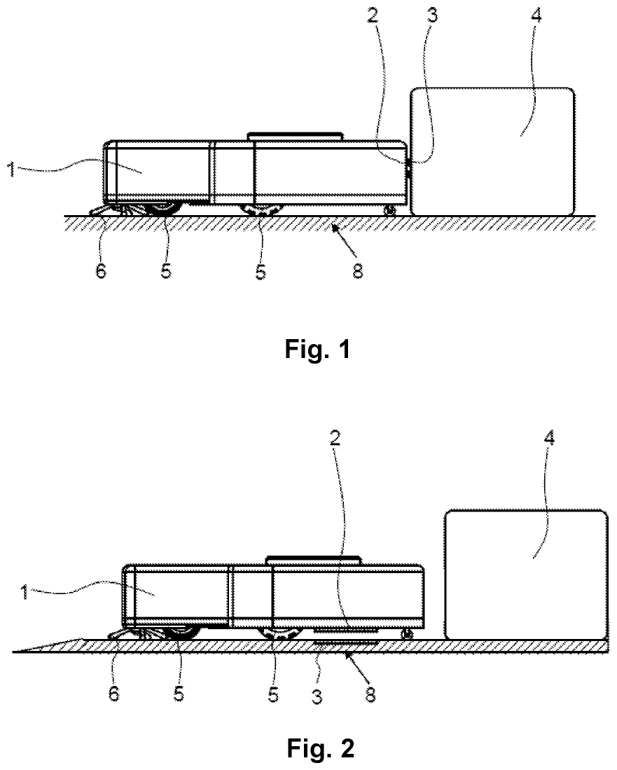

FIG. 1 shows an embodiment of a cleaning device 1 in a side view. The cleaning device 1 has an electrical interface 2 for interacting with an electrical counter-interface 3 of a base station 4. The base station 4 is designed to charge an energy storage device, in this case a battery, of the cleaning device 1. The cleaning device 1 has a means of transportation 5 with a traction drive and at least one cleaning tool 6, in this case a rotating brush. The electrical interface 2 has two electrical contacts and the electrical counter-interface 3 has two electrical counter-contacts that are in contact with one another as soon as the cleaning device 1 is completely situated on the base station 4 in the service position.

FIG. 2 shows another embodiment of a cleaning device 1 in a side view. The cleaning device 1 is situated in a service position 8 on a base station 4, with the base station 4 being designed differently from the base station 4 according to FIG. 1. According to FIG. 2, the electrical interface 2 of the cleaning device 1 is designed as a secondary coil and the electrical counter-interface 3 of the base station 4 is designed as a primary coil, so that the energy storage device of the cleaning device 1 can be charged inductively.

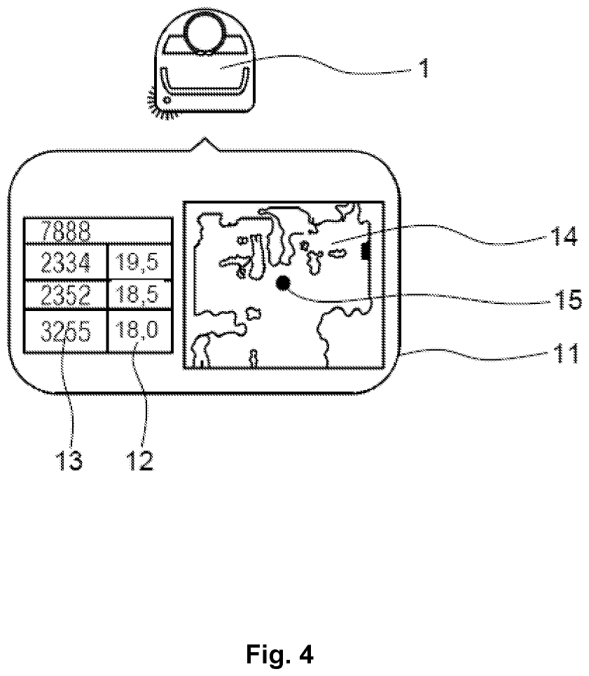

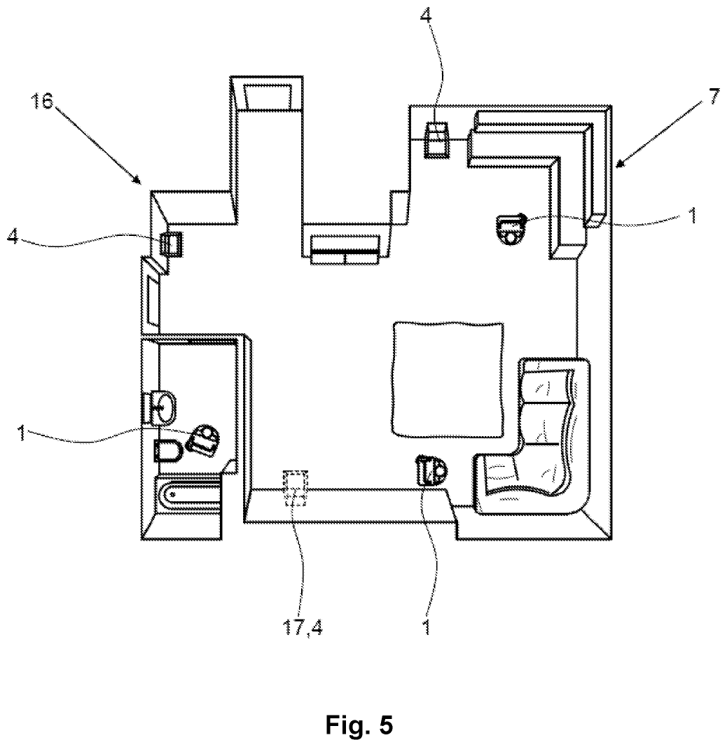

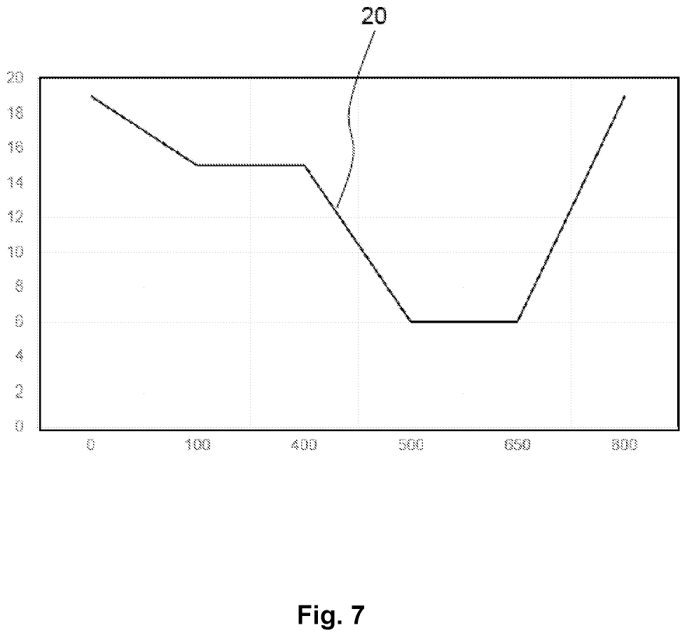

The cleaning devices 1 of the embodiments in FIG. 1 and FIG. 2 are designed and set up to move autonomously in a processing environment 7, shown as an example in FIG. 5, in this case an apartment, and to carry out cleaning tasks. According to FIG. 1 and FIG. 2, both cleaning devices 1 are also designed and set up to move into the service position 8 of a base station 4 for service purposes, in which a voltage is provided via the electrical interface 2, specifically for charging the energy storage device of the cleaning device 1. According to FIG. 1 and FIG. 2, the cleaning devices 1 are also designed and set up, at least in the service position 8, to determine at least one measured value present at the electrical interface 2 and/or at least one measured value of a voltage curve 20—see FIG. 7—present at the electrical interface 2 to be determined as a means of identification over a period of time, and, using the means of identification, i.e. at least one measured value, to determine at least range of service functions 13—see FIG. 4—of the base station 4.

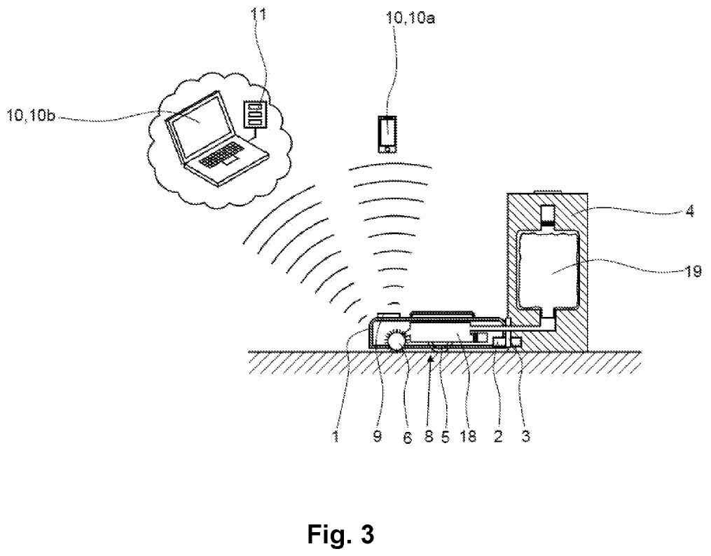

FIG. 3 shows an alternative embodiment of a cleaning device 1 in a sectional side view. The cleaning device 1 also has an electrical interface 2 which, in the illustrated service position 8, makes electrical contact with an electrical counter-interface 3 of the base station 4. The cleaning device 1 has a cleaning tool 6 in the form of a brush roller and means of transportation 5 with traction drive in order to move autonomously in a processing environment 7—see FIG. 5. The cleaning device 1 also has a dirt collection container 18 that can be emptied by the base station 4 in that the dirt present in the dirt collection container 18 is sucked into a dirt collection container 19 of the base station 4. The range of service functions 13 of the base station 4 consequently includes charging the energy storage device of the cleaning device 1 and emptying the dirt collection container 18.

At least in the illustrated service position 8, the cleaning device 1 according to FIG. 3 is also designed and set up to determine at least one measured value of the voltage present at the electrical interface 2 and/or at least the measured value of a voltage curve 20—see, for example, FIG. 7—present at the electrical interface 2 as a means of identification. In this embodiment, the specified measured value or the specified measured values—the means of identification—are transmitted over at least one communication interface 9 to determine the range of service functions 13 by a spatially separated data processing device 10, which is embodied, for example, as a smartphone 10a or a server 10b.

The spatially separated data processing device 10 determines the range of service functions 13 of the base station 4, specifically by comparison with voltage measured values 12 in a storage device 11—see FIG. 4—and transmits the determined range of service functions 13 via the communication interface 9 back to the cleaning device 1, specifically a data processing device 10 of the cleaning device 1.

FIG. 4 shows an embodiment of a cleaning device 1 in a top view with the contents of a symbolized storage device 11. Measured values of voltage 12 and data relating to associated service function ranges 13 of the respective base station 4 are stored in the storage device 11.

The storage device 11 is preferably designed as a non-volatile memory device.

Furthermore, the storage device 11 contains processing environment data 14, in this case a map of the processing environment 7—see FIG. 5—with position data 15. A range of service functions 13 of a base station 4 is assigned to each voltage measured value 12 in the storage device 11. The range of service functions 13 is preferably determined by comparing the determined measured value—of the means of identification—with the stored voltage measured values 12.

As an alternative to this, according to FIG. 3, it is provided that the storage device 11 is kept available by a spatially separate data processing device 10, for example a server 10b which is accessible via the internet, wherein the storage device 11 is accessible to the data processing device of the cleaning device 1 via the communication interface 9 of the cleaning device 1.

Furthermore, as an alternative to this, it is provided that the storage device is kept available by a data processing device 10 embodied as a smartphone 10a and that the data processing device of the cleaning device 1 can access the storage device via the communication interface 9 of the cleaning device 1 or data from the storage device can be retrieved via the communication interface 9.

FIG. 5 shows an embodiment of a processing environment 7 with multiple cleaning devices 1 and multiple base stations 4[[ ]] that together form a cleaning system 16. The cleaning devices 1 are designed, for example, like the cleaning device 1 according to FIG. 4. The cleaning devices 1 are designed and set up, for example, in such a way that at least one determined range of service functions 13 of each base station 4 is linked to position data 15 of the respective base station 4 in the processing environment 7 according to FIG. 5. For example, the position data 15 and the data on the range of service functions 13 are combined in the processing environment data 14 according to FIG. 4. The processing environment data 14 can be equated with an environment map, for example. As a result, the position data 15 of the base station 4 with the associated range of service functions 13 can be taken into account when creating and/or adjusting a navigation and/or cleaning task plan for a cleaning device 1.

At least one of the cleaning devices 1 according to FIG. 5 is also designed and set up in such a way that, using the determined range of service functions 13 in conjunction with the position data 15 and another item of data, for example data on the size of the processing environment 7 and data on the degree of soiling, at least a part of the processing environment 7, at least one probable point in time or period of time for a service requirement of the cleaning device 1 can be determined.

The expected point in time or period of time for a service requirement is used when creating and/or adjusting a navigation and/or cleaning task plan for the cleaning device 1, so that the cleaning device 1 is at least in the local vicinity of one of the base stations 4 at the expected service time, which, with its range of service functions 13, can at least partially, but preferably completely, process a service function range of the cleaning device 1 that is required at the expected service time.

At least one of the cleaning devices 1 according to FIG. 5 is also designed and set up in such a way, using at least one determined range of service functions 13 for a base station 4 and using data of at least one further cleaning feature, for example data on the usual soiling of the processing environment 7, data on the desired cleaning intensity and data on the capacity of the dirt collection container 18 to determine at least one optimized location 17 for a base station 4 in the processing environment 7.

The determined, optimized location 17 can be output to a user, for example via a data processing device 10 shown in FIG. 3, specifically the smartphone 10a, as a display device. The data processing device 10, specifically in the form of the smartphone 10a, can also be used by the user, for example as an input device in order to discard the optimized location 17 proposed by the cleaning device 1 according to FIG. 5, or to confirm it as a future base station 4 with a certain range of service functions 13.

If the optimized location 17 is confirmed as a future location, an additional base station 4 must then be arranged by the user at the optimized location 17 or one of the existing base stations 4 must be relocated to this location 17.

The cleaning system 16 according to FIG. 5 comprises three cleaning devices 1 and two base stations 4. The base stations 4 are designed and set up to control the electrical counter-interface 3 in such a way that the voltage that can be measured by the cleaning device 1, in particular at least at a predetermined point in time, is changed at least temporarily, and/or that, in particular over a predetermined period of time, a predetermined voltage curve is generated.

Furthermore, all cleaning devices 1 are designed and set up to determine at least one measured value of the applied voltage and or at least one measured value of a voltage curve 20 as a means of identification, at least in the service position 8 at least one base station 4.

The determination of the range of service functions 13 is then carried out either according to the embodiments of FIGS. 1 and 2 by the cleaning devices 1, specifically the respective data processing device of the cleaning devices 1 themselves, or according to FIG. 3, on a data processing device 10 that is spatially separated from the cleaning device 1, for example a smartphone 10a or a server 10b.

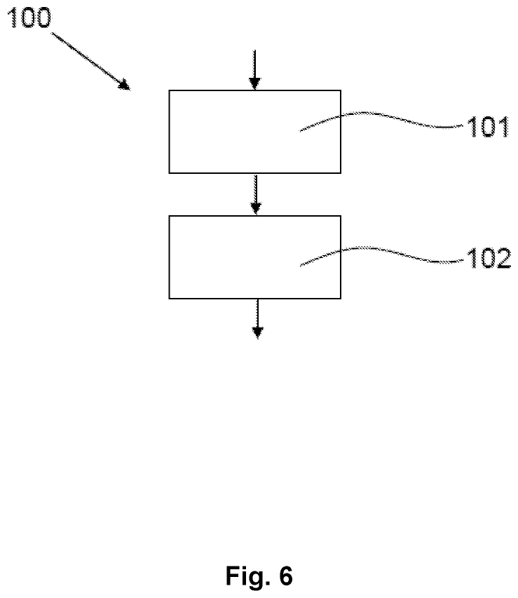

FIG. 6 schematically shows the sequence of a method 100 for operating a cleaning device 1, specifically a cleaning device 1 according to one of the embodiments described above. The cleaning device 1 comprises at least one electrical interface 2 for interacting with an electrical counter-interface 3 of at least one base station 4, at a minimum for charging an energy storage device of the cleaning device 1.

The cleaning device 1 is designed and set up to move autonomously, at least in a processing environment 7, to carry out cleaning tasks and to move to a service position 8 at a base station 4 for service purposes. In the service position 8, voltage is provided via the electrical interface 2, specifically for the energy storage device of the cleaning device 1.

The procedure 100 includes the following procedure steps:
Determination 101 of at least one measured value of the voltage at the electrical interface 2 of the cleaning device 1 in the service position 8 and/or determination 101 of at least one measured value of a voltage curve at the electrical interface 2 of the cleaning device 1; and
Determination 102 of at least one range of service functions 13 of the base stations 4 through comparison of at least the determined measured value of the voltage and/or the measured value of the voltage 20 with at least one voltage measured value 12 kept available in a storage device 11. The voltage measured values 12 kept available in the storage device 11 are respectively assigned data on the range of service functions of a respective base station 4.

FIG. 7 shows an example of a voltage curve 20 over time at an electrical interface 2 of a cleaning device 1 in a service position 8 at a base station 4. The time after the connection of the electrical interface 2 to the electrical counter-interface 3 of the base station 4 is plotted in milliseconds on the x-coordinate. The voltage present at the electrical interface 2 is plotted in volts on the ordinate. In this embodiment, the voltage curve 20 is determined over a period of 800 ms after the electrical interface 2 has been connected. The standardized charging voltage for the energy storage device at the electrical interface 2 is 19 V, for example. The base station 4 is designed and set up in this case in such a way that the voltage drops to 14.5 V over a period of 100 ms, then remains at this voltage for up to about 400 ms, and drops to about 6 V after about 400 ms to 500 ms. The voltage then increases again up to a point in time of 800 ms after connection, so that 800 ms after connection it once again corresponds approximately to the standardized charging voltage of 19 V. This characteristic voltage curve 20 is recorded by the cleaning device 1 and is used as a means of identification when determining the range of service functions 13 of the base station 4.

The invention is not limited to the exemplary embodiments shown and described, but also includes all embodiments that have the same effect within the purpose of the invention. It is expressly emphasized that the exemplary embodiments are not limited to all the features in combination. Rather, each individual partial feature can also have an inventive significance independently of all other partial features. Furthermore, the invention has not yet been limited to the combination of features defined in any embodiment, but can also be defined by any other combination of specific features of all the individual features indicated overall. This means that in principle practically every individual feature of any embodiment can be omitted or replaced by at least one individual feature indicated elsewhere in the application. In other words, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A cleaning device (1), having at least one electrical interface (2) for interacting with an electrical counter-interface (3) of at least one base station (4) at least for charging an energy storage device of the cleaning device (1),
wherein the cleaning device (1) is at least designed and set up to move autonomously in at least one processing environment (7), to carry out cleaning tasks and to move into a service position (8) at a base station (4) for service purposes,
wherein the cleaning device (1) is also at least designed and set up in such a way that, at least when it is in the service position (8), at least one measured value of a voltage present at the electrical interface (2) and/or at least one measured value of a voltage curve (20) present at the electrical interface can be determined as a means of identification;
wherein the cleaning device uses the means of identification to determine at least one range of service functions (13) of the base station (4) or at least to provide the means of identification at at least one communication interface (9) for use in the determination of a range of service functions (13) by a data processing device (10).

2. The cleaning device (1) according to claim 1, wherein the determination of the range of service functions (13) comprises a comparison of at least one measured value with measured values of voltage kept available in a storage device (11), with different voltage measured values being assigned to base stations (4) with different ranges of service functions (13).

3. The cleaning device (1) according to claim 2, wherein the cleaning device (1) is designed and set up in such a way that at least one measured value of the voltage and/or at least one measured value of the voltage curve is determined immediately after the cleaning device (1) has been situated in the service position (8) and/or that at least one voltage measured value is determined at least at a predetermined point in time and/or that at least one voltage measured value is determined after at least a predetermined elapse of time after the cleaning device (1) has been situated in the service position (8).

4. The cleaning device (1) according to claim 1, wherein the cleaning device (1) is designed and set up in such a way that the determined range of service functions (13) for each base station (4) is linked to position data of the respective base station (4) in the processing environment (7).

5. The cleaning device (1) according to claim 4, wherein the cleaning device (1) is designed and set up in such a way that, using at least one determined range of service functions (13) in conjunction with the position data (15), at least one base station (4) and at least one other item of data is used from the following:
data about the size of the processing environment (7),
data about the degree of soiling of at least part of the processing environment (7),
data about the status of an energy storage device of the cleaning device (1), and/or
data about regeneration of a wet cleaning pad and/or data about the fill status of a dirt collection container (18),
to determine at least one probable point in time or period of time for a service requirement for the cleaning device (1), with the probable point of time or period of time being used when creating and/or adjusting a navigation and/or cleaning task plan for the cleaning device (1).

6. The cleaning device (1) according to claim 2, wherein the data processing device of the cleaning device (1) is designed and set up in such a way as to determine at a specific point in time a current service requirement for the cleaning device (1) and using the current service requirement of the cleaning device (1), to select at least one base station (4) that is at least partially suitable for the service requirement determined.

7. The cleaning device (1) according to claim 1, wherein the cleaning device (1) is designed and set up in such a way, using at least the determined range of service functions (13) for at least one base station (4) and using data from at least one of the following additional cleaning features:
data on the usual soiling of the processing environment (7),
data on the desired cleaning intensity of the processing environment (7),
data on the intake capacity of a dirt collection container (18),
data on the regeneration of a wet cleaning pad and/or the maximum running time of an energy storage device,
data on normal contamination of the processing environment (7) determined during previous navigation and/or cleaning movements,
data on the desired cleaning intensity of the processing environment (7),
data on the intake capacity of a dirt collection container (18), and/or
data on the regeneration of a wet cleaning pad and/or the maximum running time of an energy storage device,
to determine at least one optimized location (17) for at least one base station (4) in the processing environment (7), in order to give at least one determined optimized location (17) to a user via at least one display device.

8. The cleaning device (1) according to claim 1, wherein the cleaning device (1) is designed and set up in such a way that it receives data about at least one preferred location of the base station (4) in the processing environment (7) via at least one input device,
wherein the cleaning device uses the data about the preferred location, the determined range of service functions (13) for at least one base station (4), and data from at least one of the following additional cleaning characteristics:
data on the usual soiling of the processing environment (7),
data on the desired cleaning intensity of the processing environment (7),
data on the intake capacity of a dirt collection container (18),
data on regeneration of a wet cleaning pad and/or the maximum running time of an energy storage device,
data on normal soiling of the processing environment (7) determined during previous navigation and/or work movements,
data on the desired cleaning intensity of the processing environment (7),
data on the intake capacity of a dirt collection container (18), and/or
data on regeneration of a wet cleaning pad and/or the maximum running time of an energy storage device,
to determine the preferred location for its suitability as a location in the context of a navigation and/or cleaning task plan.

9. A cleaning system (16), the cleaning system (16) comprising at least one base station (4) and at least one cleaning device (1),
wherein the cleaning device (1) has at least one electrical interface (2) for interacting with an electrical counter-interface (3) of the base station (4) at least for charging at least one energy storage device of the cleaning device (1),
wherein the cleaning device (1) is designed and set up to move autonomously at least in a processing environment (7), to carry out cleaning tasks and to move into a service position (8) at a base station (4) for service purposes,
wherein voltage can be provided in the service position (8) via the electrical counter-interface (3) and the electrical interface (2),
wherein the cleaning device (1) is also designed and set up in such a way that, at least in the service position (8), to determine at least one measured value of the voltage present at the electrical interface (2) and/or at least one measured value of the voltage curve (20) as a means of identification,
wherein the cleaning device uses the means of identification, to determine at least one range of service functions (13) of the base station (4) or provides at least the means of identification at at least one communication interface (9) for use in determining the range of service functions (13) by means of a data processing device (10).

10. The cleaning system (16) according to claim 9, wherein at least two cleaning devices (1) and/or at least two base stations (4) are present,
wherein each cleaning device (1) is designed and set up to determine the range of service functions (13) of each base station (4) in the service position (8) or to provide at least one measured value at at least one communication interface (9) for use in determining the range of service functions (13) by means of a data processing device (10).

11. The cleaning system (16) according to claim 9, wherein at least two base stations (4) are present, and that there is a difference in the voltages that can be determined for base stations (4) with a different range of functions.

12. The cleaning system (16) according to claim 9, wherein the base station (4) is designed and set up to control the electrical counter-interface (3) in such a way that the voltage that can be measured by the cleaning device (1) is changed at least temporarily.

13. The cleaning system (16) according to claim 9, wherein at least one data processing device (10) is present, and that the data processing device (10) is designed and set up in such a way that at least at one point in time, the determination of the need for service of at least one cleaning device (1) is made, and using the current service requirement of at least one cleaning device (1), at least one base station (4) is selected that is suitable for this service requirement.

14. A procedure (100) for operating at least one cleaning device (1), that has at least one electrical interface (2) for interacting with an electrical counter-interface (3) of at least one base station (4), with the cleaning device (1) being at least designed and set up to move autonomously in at least one processing environment (7), to carry out cleaning tasks and to move into a service position (8) on the base station (4) for service purposes, and when it is in the service position (8), voltage can be provided via the electrical interface, which comprises at least the following procedural steps:
Determination (101) of at least one measured value of the voltage at the electrical interface (2) of the cleaning device (1) in the service position (8) and/or determination (101) of at least one measured value of a voltage curve (20) at the electrical interface (2) of the cleaning device (1) in the service position (8) as a means of identification, and
Determination (102) of at least one range of service functions (13) of the base station (4) using the means of identification by comparing at least the determined voltage measured value and/or the measured value of the voltage curve (20) with voltage measured values held available in at least one storage device wherein the voltage measured values that are held available in the storage device, are assigned to data on the range of service functions (13) of different base stations (4).

15. A computer program product, comprising instructions which, when the program is executed by a processor unit of a data processing device, directs the data processing device to determine at least one current service requirement of a cleaning device (1) at least one point in time, to select at least one suitable base station (4) for processing at least part of the current service requirement using data on known ranges of service functions assigned to individual base stations (4), and to direct the cleaning device to move to the service position (8) at the selected base station (4).

16. The cleaning device (1) according to claim 2, wherein the storage device is a database.

17. The cleaning device (1) according to claim 2, wherein the storage device (11) is kept available by a data processing device of the cleaning device (1) or that the storage device (11) is kept available by a spatially separated data processing device (10), such that the storage device (11) is accessed by a data processing device of the cleaning device (10) via at least one communication interface (9).

18. The cleaning device (1) according to claim 6, wherein after selection of the at least one base station (4), the data processing device (10) directs the cleaning device (1) to move at least in the direction of a selected base station (4) with the known position data (15), or to direct it to move to at least any base station (4) to determine the range of service functions (13).

19. The cleaning system (16) according to claim 11, wherein the difference in voltages is at least 1.0 V.

20. The procedure (100) according to claim 14, wherein the storage device is a database.
